(19) United States
(12) Patent Application Publication
(10) Pub. No.: US 2013/0325562 A1
(43) Pub. Date: Dec. 5, 2013

(54) Electronic voting machine that randomly stores and sequentially retrieves cast ballots for viewing after the election is over

(71) Applicant: Robert Burton Nordberg, (US)

(72) Inventor: Robert Burton Nordberg, (US)

(21) Appl. No.: 13/487,230

(22) Filed: Jun. 3, 2012

(51) Int. Cl. G07C 13/00

(52) U.S. Cl. 705/12

(57) ABSTRACT

An electronic voting machine that shuffles and prints out the cast ballots in a random order. To prevent computer hacking, the controlling computer communicates only with the voter while the election is in progress, and the election results are only computed after election is over and all of the cast ballots have been made available to the public.

### SEQUENCE LISTING

Not applicable

### CROSS-REFERENCE TO APPLICATIONS RELATED

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### BACKGROUND OF INVENTION

1. Technical Field

This invention relates to secure voting machines where great heed is given to audit ballots while retaining privacy.

2. Background Art

Citizens in democratic governments and members of democratic institutions are given the right to express their preferences by the act of voting. To assure that this right is not compromised, great efforts must be made to guarantee that the voting process used provides for both ballot auditing and at the same time anonymity.

Mechanical voting machines typically include a system of mechanical switches and levers that are actuated by the voter to increment mechanical counters. These are expensive, are not tamper proof, and leave no audit trail.

Punched cards have been used in mechanical/electronic systems. They have the possibility of producing an audit trail, but unfortunately they can produce hanging chads, and at times they position the holes inaccurately. They leave an audit trail, however, that audit trail can be corrupted by ballot box stuffing and errors in reading by machines and human beings.

In recent voting inventions, the latest technology has been used to facilitate speed and efficiency, but that technology has not been able to gain the ability to audit while maintaining anonymity. Privacy will not allow the ballot to contain the name of the voter, nor allow the ballots to somehow point back to the voter, who could then verify selections and facilitate identification of excess or stuffed ballots. But privacy is important to assure the voter a feeling of security and to quell any threat of retribution.

All present computer based systems are subject to errors in programming. If the computer code is protected by private license it is even more subject to errors because the code hasn't been viewed and checked by the general public. Open source programs are codes that are developed and checked by many programmers interested in volunteering their time for the public good, and are less likely to have errors. Once having attained a high degree of accuracy, and having been approved by election boards, they are still subject to corruption by hackers and unscrupulous partisans. This invention greatly improves security by controlling the number of hardware inputs, and by separating the tabulating software from software that is active during the voting session.

### BRIEF SUMMARY OF THE INVENTION

In accordance with the present invention all cast ballots are randomly stored on a non-volatile, random access storage medium. Once stored, the specific random address is deleted and cannot be recovered. After the election is over, all ballots are gathered sequentially from the memory, printed and also shown on a visual display. The code used to calculate election results is activated after the voting period. No hacking can be done during the post election tabulation period as at that time the cast votes are available to everyone. After the election an accurate count of the ballot selections is made and displayed. Each cast ballot is printed after the election providing a facsimile for any interested voter of their exact cast ballot. To further guard against hacking, this computer specifically contains no input electrical data lines other than a voting device like a touch screen monitor and a removable disc drive for inputting the specific locally defined ballot.

### BRIEF DESCRIPTION OF THE DRAWINGS

FIG. 1 shows a block diagram of the electronic voting machine.

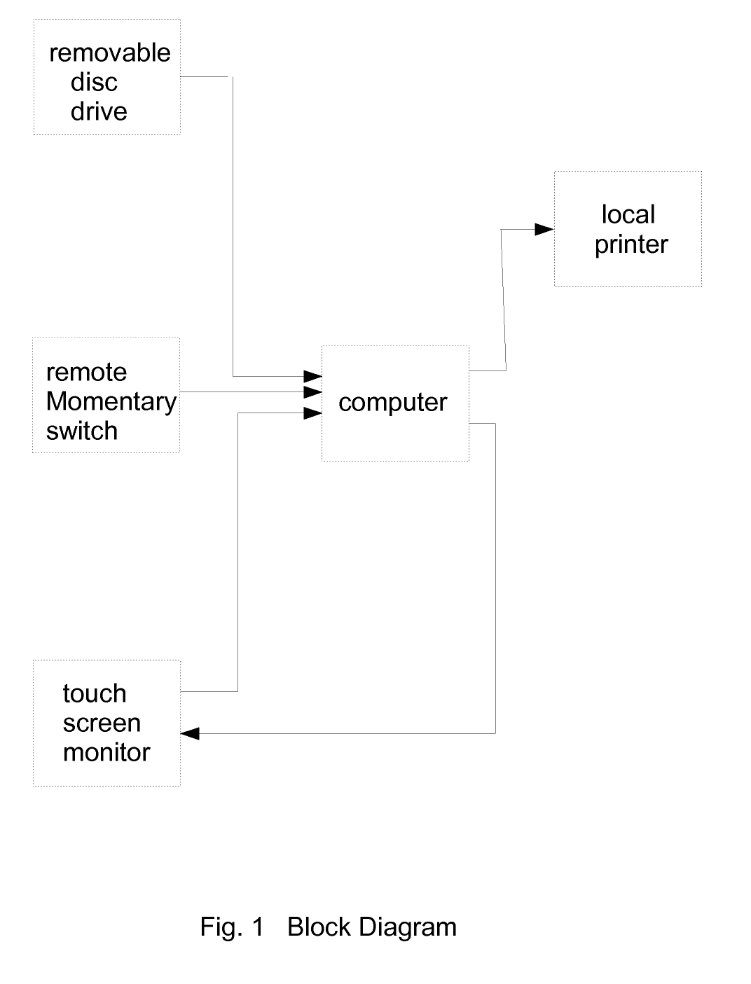

FIG. 2 shows a flow chart of the election.

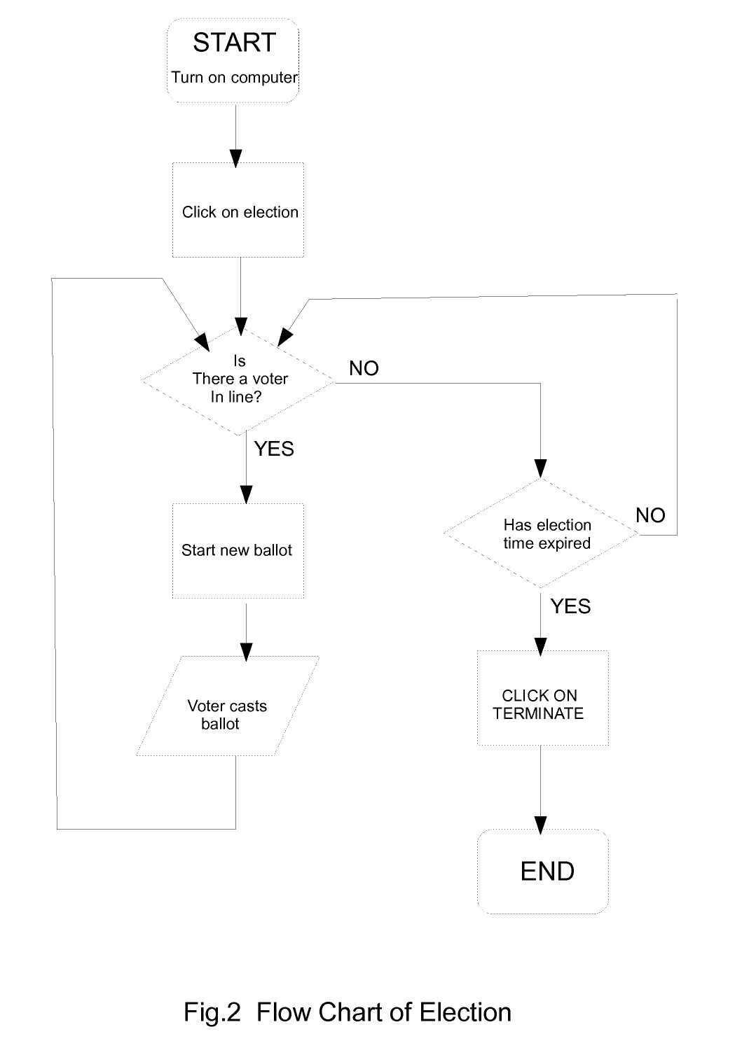

### DETAILED DESCRIPTION OF THE INVENTION

### 1. Preferred Embodiment

This electronic voting machine includes a computer which is restricted to having no electrical input channels which could input data during an election other than that from the voter. A second input channel which is used prior to and after an election is a removable disc drive, and a third input is a remote momentary on/of switch. used by election officials to control the election. Most importantly the computer has no electrical input lines which could be used by hackers to falsify the election results. A touch screen display is used by the voter to input ballot selection and to cast the ballot. The ballot definition is input using the removable disc drive and after the election is over it along with a printer outputs all of the cast ballots and the election results. Election officials initiate a new election and terminate an election by simultaneously actuating the remote switch in conjunction with actuating a touch screen command. During the voting period of the election the momentary switch allows the election personnel to initiate each new ballot, and a touch screen monitor allows the voter to input ballot selections and to cast the ballot.

By storing the ballots into memory at random addresses and purposely not retaining those addresses, the order in which each voter stood in line to cast the ballot remains unknown, protecting the voter's anonymity. If, for instance, the ballots are retrieved sequentially, they become anonymously available post election for counting and voter review. The tabulating task of the program is performed after the election has terminated. This simplifies the code used during voting and makes it more tamper proof.

Like the mechanical voting machine, this electronic voting machine is a stand alone unit with no easy way to allow corrupting activity and which simply supplies the number of cast votes for each ballot selection after the election is over. However, this invention is superior to the mechanical voting machine which can be tampered with any time before the election. Using this invention with open sourced code, just prior to an election, a computer memory dump can be performed and compared with a certified copy of the code in the removable disc drive to assure that the programming has not been corrupted.

Rather than trusting transmission of data to a remote site for tabulation, which could easily be tampered with, the election results produced by this machine at election termination cannot be changed. Besides posting the results at each polling place, hard copies can be given to the voluntary observers making them personal witnesses. Even though the communications media may electrically transmit election data for unofficial use, the official numbers are arrived at only after much corroboration by individual observers.

By having a computer control the election process, the number of ballots rejected because of human mistakes is greatly reduced, because the computer program can insist that the voter correct some errors prior to casting the ballot.

### 2. Alternative Embodiment

There are many practical ways to runner guarantee a secure election.

1. To guarantee that there are no over votes, a controller could be added to the system which produces a consecutively numbered slip given by one election official to each voter in line, and which scans, retains and counts the slips when deposited by another election official at the voting station where new ballots are initiated.

2. The computer could output the number of cast ballots which increments and displays the count as each ballot is cast, so observers can track the total number of cast ballots

3. Several video recorders could be used to scan the voting area and record if anyone is tampering with the equipment.

4. A battery operated power supply would be highly recommended to prevent unnecessary interruptions and prevent intentional tampering.

5. For those who still don't trust this stand-alone electronic machine, a mechanical shuffler could hold each printed ballot after being cast and viewed by the voter.

1. A secure stand alone electronic voting machine, comprised of:
a removable disc drive;
a computer printer;
a voter cast ballot;
a means for voters to make selections and cast said voter cast ballot;
a remote momentary on/off switch for use by election officials;
A computer of which there is only one said computer having no input channels to receive data and communications from the outside world other than said removable disc drive said remote momentary on/off switch and said means for voters to make selections and cast said voter cast ballot;
wherein said computer stores each said voter cast ballot at a random address and completely outputs anonymously all said sequentially addressed voter cast ballots via said computer printer and said removable disc drive.

2. The secure stand alone electronic voting machine of claim 1 wherein a touch screen monitor is used as said means for voter to make selections and cast said voter cast ballot.

3. The secure stand alone electronic voting machine of claim 1 wherein a computer mouse, a computer keyboard, and a computer monitor are used as said means for voter to make selections and cast said voter cast ballot.

4. The secure stand alone electronic voting machine of claim 1 wherein said computer contains open sourced software exclusively.

5. The secure stand alone electronic voting machine of claim 1 wherein the election results are programmed to be calculated after the election has terminated.

6. The secure stand alone electronic voting machine of claim 1 wherein basically all components are housed in one frame.
